(19) United States
(12) Patent Application Publication
(10) Pub. No.: US 2015/0295406 A1
(43) Pub. Date: Oct. 15, 2015

(54) POWER SUPPLY MANAGEMENT

(71) Applicant: Garry Richmond Stewart, Kinross (GB)

(72) Inventor: Garry Richmond Stewart, Kinross (GB)

(21) Appl. No.: 14/677,754

(22) Filed: Apr. 2, 2015

(30) Foreign Application Priority Data
Apr. 15, 2014 (GB) GB1406759.9

(51) Int. Cl. H02J 3/00; G05B 15/02

(52) U.S. Cl. CPC H02J 3/00; G05B 15/02

(57) ABSTRACT

A method of reducing peak power demand on a mains-grid power supply network, comprises the steps of: a] providing a data-communication network by which a plurality of users being fed by the power supply network are communicable; b] connecting a controller associated with at least a high-power-demand electrical device of each user to the data-communication network; and c] dynamically allocating via the data-communication network a usage time slot for energization of said high-power-demand device based on demand, whereby usage of said high-power-demand devices associated with the data-communication network is controlled thereby enabling a reduction in overall peak power demand. An electronic-data-network controller and a power-supply management system are also provided.

### CROSS-REFERENCE TO RELATED APPLICATIONS

This application claims priority from British patent application number GB 1406759.9, entitled “Improvements in or Relating to Power Supply Management”, which was filed on 15 Apr. 2014, the contents of which are hereby incorporated by reference for any purpose in their entirety.

### FIELD OF THE TECHNOLOGY

The present invention relates to a method of reducing peak power demand on a mains-grid power supply network, to an electronic-data-network controller which is specifically adapted for use with the said method, and to power-supply management system incorporating one or more of the said controllers and/or the said method.

### BACKGROUND OF THE INVENTION

The traditional mains power supply grids provide a centralized, producer-controlled electricity network which is reactive to demand rather than being proactive. As a consequence, a peak demand or power requirement surge has always been problematic and thus expensive to accommodate, resulting in the power suppliers having to purchase extra energy at increased cost to meet these possible peaks or surges. When a sudden draw is called for typically by high-power electrical device which are operable for a short periods, such as but not exclusively kettles, air-conditioners, washing machines and tumble dryers, sub-plants must be utilised to supplementarily supply power into the grid network to meet the demand. These sub-plants are costly due to still requiring maintenance and upkeep even when sitting idle, along with fossil fuels to be purchased at or close to the time of operation, and thus being at an inflated price. Furthermore, this increases the discharge into the environment of damaging greenhouse gasses.

In the event that sub-plants are not utilised, then the power stations themselves have to be initially constructed to meet the difficult-to-predict peak power demands, leading to a much more costly infrastructure.

The use of a so-called ‘smart-grid’ system has thus been mooted, utilising a two-way flow of real-time information and electricity to and from the end power-consumer. In theory, this should thus allow an energy producer to much more easily accommodate an energy draw or load requirement, allowing smoothing and balancing of the demand, and consequently a reduction in costly infrastructure and supplementary purchasing and production.

A smart-grid system is intended to provide a less centralised automated power distribution network which is more consumer interactive, thus being proactive rather than reactive. However, the actual implementation of such a smart-grid system and the processes therebehind have not to date been fully explored.

The present invention therefore seeks to provide, at least in part, a solution to these problems, thereby allowing improved implementation of a so-called smart-grid system for power supply management.

### BRIEF SUMMARY OF THE INVENTION

According to a first aspect of the invention, there is provided a method of reducing peak power demand on a mains-grid power supply network, the method comprising the steps of: a] providing a data-communication network by which a plurality of users being fed by the power supply network are communicable; b] connecting a controller of at least a high-power-demand electrical device of each user to the data-communication network; and c] dynamically allocating via the data-communication network a usage time slot for energisation of said high-power-demand device based on demand, whereby usage of said high-power-demand devices associated with the data-communication network is controlled thereby enabling a reduction in overall peak power demand.

According to a second aspect of the invention, there is provided an electronic-data-network controller for at least a high-power-demand electrical device, and preferably specifically adapted for use with a method in accordance with the first aspect of the invention, the controller comprising a control element which communicates with at least a high-draw electrically powerable element of an electrical device so as to time control energisation thereof; a user input element which inputs an energisation request for energisation of the electrical device; a communication element which communicates with a distributed computer network the energisation request and which receives in return at least one dynamically allocated usage time slot from the distributed computer network based on a real-time and/or predicted energy demand across a predetermined number of said electrical devices on the distributed computer network, the dynamically allocated usage time slot being outputable to the control element; and a display element which displays the dynamically allocated usage time slot.

According to a third aspect of the invention, there is provided a power-supply management system comprising a control hub, at least one electronic-data-network controller, preferably in accordance with the second aspect of the invention, and an electronic data network via which the control hub and controller intercommunicate, the control hub having a dynamic allocation system which dynamically allocates at least one usage time slot on receipt of an energisation request for an electrical device from the controller.

According to a fourth aspect of the invention, there is provided a power-supply management system comprising at least two electronic-data-network controllers, preferably in accordance with the second aspect of the invention, and an electronic data network via which the controllers intercommunicate, the controllers having a dynamic allocation system distributed between the controllers which dynamically allocates at least one usage time slot on input of an energisation request corresponding to an electrical device associated with one said controller.

Furthermore, the power-supply management system of the third and fourth aspects may further comprise a secondary power supply network having a distinct separate power supply for energising the or each electrical device during the allocated usage time slot in preference to mains power generated for the mains power supply network.

### BRIEF DESCRIPTION OF THE DRAWINGS

The invention will now be more particularly described, by way of example only, with reference to the accompanying drawings, in which:

FIG. 1 shows a front side view of one embodiment of an electronic-data-network controller, in accordance with the second aspect of the invention and which is specifically adapted for use with a power-supply management method according to the first aspect of the invention;

FIG. 2 shows a back side view of the electronic-data-network controller, shown in FIG. 1; and

FIG. 3 is a simplified diagrammatic representation of a power-supply management system, in accordance with the third aspect of the invention, utilising a plurality of the electronic-data-network controllers as shown in FIG. 1.

### DETAILED DESCRIPTION OF THE INVENTION

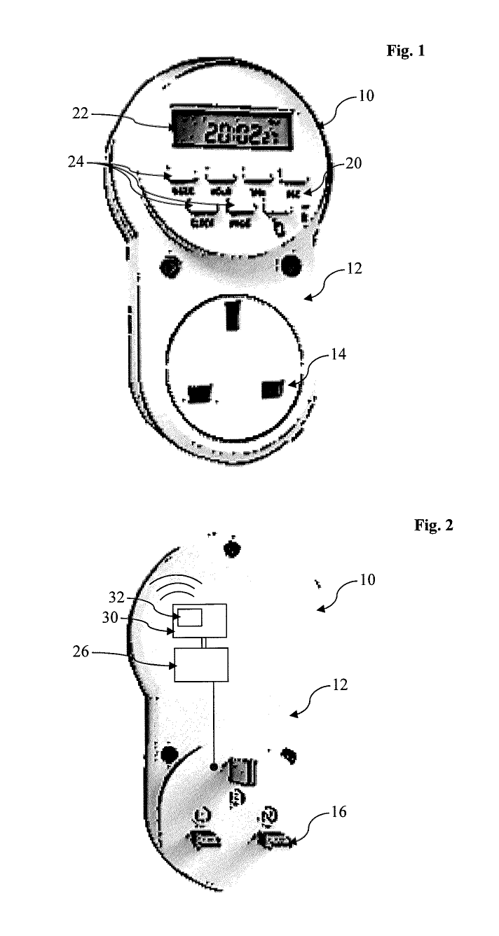

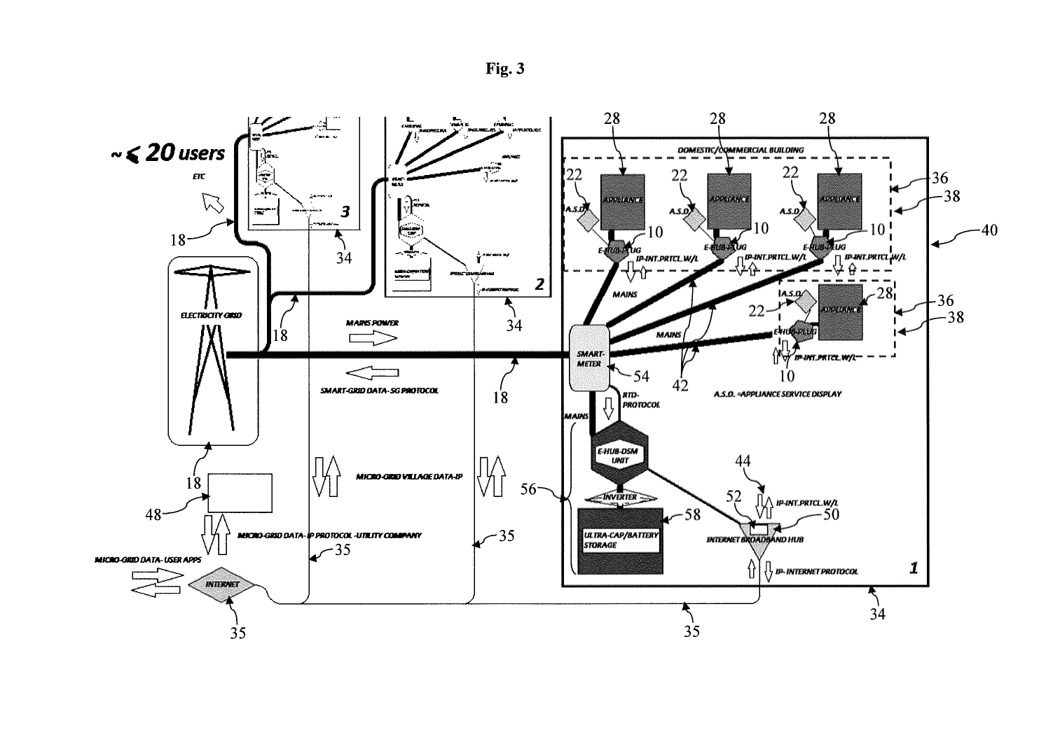

Referring firstly to FIGS. 1 and 2 of the drawings, there is shown one example of an electronic-data-network controller 10 which comprises a controller housing 12 having an appliance socket 14 at one side, in this case being a front side, and wall-socket plug 16 at another side, in this case being the back side of the housing 12 and opposite the appliance socket 14. The appliance socket 14 is adapted to receive an electrical plug of an appliance, and the wall-socket plug 16 is adapted to be received in a wall socket providing an electrical outlet and interfacing with a mains electricity power grid 18.

The controller housing 12 is, for example, a two part, preferably moulded plastics, housing which is hollow or substantially hollow to enable the required circuitry to be incorporated. The housing 12 in this case is elongate and cuboidal for ease of use, but other shapes can be considered, such as circular, cylindrical, and spherical.

A user interface 20 is provided on a front of the housing 12, in this case above the appliance socket 14, and a user display 22 is positioned above the user interface 20 and within easy line of sight for a user. In this case, the user interface 20 includes a plurality of spaced apart mechanical buttons 24 forming a keyboard or partial keyboard, and the display 22 may be an LED, OLED, LCD, electroluminescent sheet, or even a nonemissive unit. A benefit of this latter type of unit is that a nonemissive display draws minimal power whilst still maintaining a visually readable output. Such a non-light-emitting display may conveniently be a cataphoretic or electrophoretic display, and is preferably bistable, enabling displayed information to be visually maintained without continuous energisation.

Optionally, the user interface may utilise soft-buttons or digital buttons or inputs, via for example a touch- or pressure-sensitive screen. In this case, the mechanical buttons 24 may be dispensed with, and as such the user interface and display may be integrated with each other. It is also feasible that other kinds of user input element and/or display element may be considered, such as a potentiometer or a remote telecommunications device thus doing away with the need for a dedicated user interface 20 and/or display 22 on the housing 12 itself.

Within the housing 12 is provided a control circuit 26 which interfaces with the electrical appliance 28 plugged into the appliance socket 14 to control activation of the appliance 28. A communications circuit 30 is also provided which utilises an electronic-data transceiver 32 for two-way communication with a distributed computer network, typically being a telecommunications network 35, such as the Internet.

The user interface 20 communicates with the communications circuit 30, which in turn can output energisation requests and may itself be interrogatable to a limited defined extent by other electronic-data-network controllers 10, as will be understood below. The communications circuit 30 also interfaces with the control circuit 26 which enables control of the electrical appliance or device 28 accordingly, as will be described in greater detail hereinafter.

Although in this embodiment the electronic-data-network controller 10 is separate of and preferably remote from the electrical appliance or device 28, it may be integrated as part of the electrical device 28 to be controlled. In this case, the housing would typically be the housing of the appliance or device 28, and the control circuit 26 would interface more closely with an electrically powerable element of the electrical device 28.

It is preferred that the aforementioned electrical appliance or device 28 is a high-power demand device, and the electronic-data-network controller 10 is therefore adapted accordingly. High-power demand devices are one of the major causes of peak or spiking electrical demand. Such devices are typically kettles, air conditioners, tumble dryers and washing machines to name just a few. Their usage is relatively short, typically being in a range of two to three minutes to two to three hours, with possible activation/deactivation cycling therebetween. However, their power draw during these activity periods can be high, in the order of several kilowatts. Consequently, simultaneous energisation of such high-power-demand electrical devices results in a surge in electricity demand, and thus the problem described above with peaks in demand.

By therefore defining energy-user groups 34 incorporating one or more energy users 36, for example, five to thirty premises 38, and more preferably ten to twenty premises 38, with one or more, preferably high-power demand, electrical devices 28 in each premises 38, a power-supply management system 40 can be implemented to control and reduce peak power demand on a mains-grid power supply network 42 to the energy-user group 34.

In this embodiment, a predefined electronic data network 44 is utilised to which each premises 38 of a said energy-user group 34 is connected. The electronic data network 44 is preferably the aforementioned telecommunications network 35 implemented by distributed interconnected computers and servers and is thus conveniently the Internet 35. However, any suitable data-communication network may be utilised.

The electronic data network 44 is clearly defined and private, with for example an energy supply company 48 regulating and moderating the members of each energy-user group 34 and thus the premises 38 forming the energy-user group 34. For example, it may be more preferable to have specific energy-user groups consisting of only domestic properties, and specific energy-user groups consisting of only commercial properties. Such specific energy-user groups 34 may then also be further sub-categorised by user and/or appliance demographic, and/or industrial or commercial field of operation.

By utilising an electronic data-transfer network, such as the Internet, although the energy-user groups 34 may all be in the same or similar vicinity to each other, for example, being an area of a village, town or city, it is just as feasible that the members of an energy-user group 34 may be in one or more different parts of a country or even the world.

The electronic data network 44 interfaces with a control hub 50, in this case being at or part of the electricity supplier 48. The control hub 50 includes a dynamic allocation system 52 dedicated to the defined energy-user group 34 which outputs control data on receipt requests from the controllers 10.

With the private electronic data network 44 and the members 36 of the energy-user group 34 defined and able to access the electronic data network 44, one or more said electronic-data-network controllers 10 are plugged into respective wall sockets within the premises 38. An electrical device or appliance 28, with particular preference being towards the high-power draw devices as explained previously, is then plugged into each controller 10 so as to be controllable thereby.

To use the electrical device 28, for example, being a kettle, the user interface 20 of the controller 10 is accessed and an energisation request made. An energisation-request signal is thus outputted to the private electronic data network 44, and thus to the control hub 50. The dynamic allocation system 52 of the control hub 50 either stores locally or interrogates the other controllers 10 forming part of the energy-user group 34 to determine availability for fulfilling the energisation request. A usage time slot signal is thus dynamically generated by the dynamic allocation system 52 and outputted to the requesting controller 10, which in turn then controls via the control circuit 26 the activation of the electrical device 28 at or during a time period in accordance with the received usage time slot.

Consequently, by asynchronously controlling a plurality of electrical devices 28, even if energisation overlap occurs to some degree with respect to some of the appliances 28, a peak energy demand is significantly reduced.

It may be preferred that the energisation requests outputted are electronically tagged or defined to allow the dynamic allocation system 52 of the control hub 50 to output usage time slot signals according to a specific kind of electrical device 28 to be energised. Consequently, although two different high-power demand devices may thus be operated simultaneously, the energisation of similar high-power demand devices would predominantly be non-simultaneously activated. By way of example, a tumble dryer and a kettle may be energised simultaneously by different users of the user-energy group, but two kettles would preferably be activated at different times.

It is preferred that a mains electricity supply 18 to the defined user-energy group is via an electricity consumption recording device 54, otherwise commonly known as a ‘smart meter’. This allows the electricity supplier 48 to monitor spikes or troughs in demand, allowing feedback into the dynamic allocation system 52 of the control hub 50. By utilising programmable logic, the dynamic allocation system 52 can incorporate the usage feedback data from the electricity consumption recording device 54 of the group 34, aiming to smooth the consumption to as great an extent as possible. If all consumption across all the energy-user groups 34 is smooth, then inherently spikes or peaks in demand will be eliminated or reduced.

It is realised that consumers forming each energy-usage group 34 will require immediate or substantially immediate access to energisation of particular electrical devices 28. To this end, an energisation request to the control hub 50 may be prioritised. However, to promote the usage of the preferred dynamically allocated usage time slots, prioritisation is preferably penalised, for example, by the use of a monetary penalty or fine implemented following the output from the controller 10 of a penalisation data signal onto the network 44 and thus back to the supplier. This would be regulated and implemented by the energy supplier 48, and would form part of the charging structure or plan that a consumer and supplier would agree to.

The energisation request from a controller 10 would also preferably include device data relating to the kind of high-power-demand device, such that the dynamic allocation system 52 of the control hub 50 can set a length of a usage time slot.

Predictive allocation may also be implemented by the programmable logic of the dynamic allocation system 52. In this way, stored device data and usage profiling relating to each user of a specific user-energy group 34 can be analysed, allowing more accommodating dynamically allocated usage time slots which are preferably immediate or closer to the time of the energisation request. Conventionally, consumers are used to receiving power on demand, and by providing the requested energisation of the device to be as on-demand as possible will increase acceptance of the power management methodology.

It is also preferred that each defined private energy-user group 34 also includes a secondary power supply network 56 having a distinct separate sub-power supply 58. Such a sub-power supply 58 is advantageously an electrical-energy storage device, such as a rechargeable battery pack or fast-cycle ultra-capacitor. For example, such an ultra-capacitor may be one to four Mega Joules and advantageously utilise Lithium Ion technology. Such a sub-power supply 58 or multiples thereof may be provided at each premises 38, or one may be provided per energy-user group 34. The control hub 50 may therefore control the mains power supply 18 to temporarily store a surplus of energy, for example, during low demand periods, in the sub-power supplies. Based on the stored charge being monitored by the control hub 50, on receipt of an energisation request, the outputted dynamically allocated usage time slot may allow power to be drawn entirely or in part from the sub-power supply 58 instead of from the mains power supply 18. Switching would be seamless, but again allows smoothing of the energy use profile of the energy-user group 34.

Although in the embodiment above a control hub is suggested, the control hub may be dispensed with in favour of the dynamic allocation system being provided and operated in distributed manner through a plurality of the electronic-data-network controllers. In this case, with the private electronic data network defined and the users of the associated energy-user group in communication via the respective controllers, the dynamic allocation system is loaded on each controller. A said controller having an input via its user interface to energise an associated appliance outputs an energisation request to the other controllers on the private electronic data network. Suitable interrogation enables the requesting controller to determine via the distributed dynamic allocation system an optimal usage time slot with preferably little or no energisation overlap. The other features described above may also apply in this variant.

It is also feasible that a hybrid power-supply management system utilising both the aforementioned control hub and controller-distributed dynamic allocation system may be implemented. An advantage with such a hybrid system would be redundancy in the case of a power or Internet outage in one or more parts of the country. Switching seamlessly between the control-hub system and the controller-distributed system allows local operation to continue irrespective as to whether the utility supplier is momentarily offline.

The above system is predominantly aimed at peak-use devices, as mentioned, but may be applicable to any type of electrical device having an energisable element.

Although the electronic-data-network controllers preferably utilise internet communication protocols for intercommunication on the defined private network and/or with a control hub associated with an electricity supplier, any suitable communication protocol can be utilised.

Furthermore, the aforementioned control hub for a specific dedicated electronic data network may be a sub-control hub, whereby a primary control hub may interface with a plurality of sub-control hubs, allowing greater degrees of control and optimisation on a wider scale of the dynamically allocated usage time slots outputted in response to received energisation requests. This has the advantage that improved programmable logic and data profiling can be rolled out more quickly on a wider scale, allowing trickle down implementation almost immediately to the associated controllers across multiple private networks.

The communication circuit preferably utilises a wireless transceiver. However, wired communication, for example through the power supply cabling, may be convenient and less susceptible to interference.

It is thus possible to provide a process or method of reducing peak power demand on a mains-grid power supply network. It is further possible to actually smooth the power demand, resulting in few or ideally no peaks and equally few or no troughs in supply. By better balancing the supply, by the additional implementation of a secondary or short-term buffered sub-grid, the requirement for sub-plants or power plants that inherently have sufficient capacity to meet the current demand peaks can be dispensed with, thereby dramatically reducing power supply costs and infrastructure. By utilising discreet, collaborative user groups of preferably around twenty premises provides flexibility in the use of, in particular, high-power demand appliances and devices, thus reducing peak loading on the mains grid. Capped tariffs by the electricity supplier encourage time shifting of the use of higher demand uses to usage time slots not being used by others in the user group. On the other hand, usage of the appliance at a time which overlaps with others is penalised. It is also possible for the energy supplier to gain valuable usage and profiling information through feedback data from the user-group network, thereby allowing improved control and dynamic usage time slot allocation systems to be updated and rolled out across multiple discreet networks of customers. It is also perfectly feasible that the user and/or the supplier may shift the user between groups dependent on their determined usage profile via the smart-meter and network monitoring. With a consumer being dynamically shifted between groups to better suit their usage profile, better economy and optimisation of use of certain appliances common to certain user groups can thus be realised. The benefit of the electronic-data-network controller allows each appliance, and specifically high-power demand devices, to be controlled and energised at the most appropriate times, minimising overlap and thus peak power demands. The controller may beneficially allow remote access by the consumer, thus allowing control, energisation or an energisation request to be undertaken remotely, for example, through a personal mobile telecommunications device, such as a so-called smartphone′. This is simplified by the user group being on a private electronic data network, and thus the consumer being able to login via a personal security access code. It is further possible to provide a controller for controlling an appliance which can be retro-fitted to existing appliances through simple ‘plug-and-play’. Equally, however, the controller may be integrated as part of the appliance, allowing control through the private electronic data network. The potential for a multiplicity of private electronic data networks effectively enables the formation of multiple sub-grid power-supply management systems, each supplying a defined user group. By then controlling and optimising the sub-grids, via a control hub linking to each network and/or via a distributed dynamic time slot allocation system locally implemented at controller level along with feedback allowing user profiling and thus optimisation, load shedding and thus better balancing of power supply and demand can be achieved.

The words “comprises/comprising” and the words “having/including” when used herein with reference to the present invention are used to specify the presence of stated features, integers, steps or components, but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

What is claimed is:

1. A method of reducing peak power demand on a mains-grid power supply network, the method comprising the steps of: a] providing a data-communication network by which a plurality of users being fed by the power supply network are communicable; b] connecting a controller of at least a high-power-demand electrical device of each user to the data-communication network; and c] dynamically allocating via the data-communication network a usage time slot for energisation of said high-power-demand device based on demand, whereby usage of said high-power-demand devices associated with the data-communication network is controlled thereby enabling a reduction in overall peak power demand.

2. A method as claimed in claim 1, wherein in step c] energisation of said high-power-demand device outside of the said allocated usage time slot generates a penalisation data signal outputted to the data-communication network.

3. A method as claimed in claim 1, wherein, in step c], a length of the usage time slot is determined by the data-communication network based on a device-feedback signal from the controller to the data-communication network relating to the kind of high-power-demand device.

4. A method as claimed in claim 3, wherein similar high-power-demand devices are automatically grouped by the data-communication network, enabling optimisation of usage time slot allocation.

5. A method as claimed in claim 1, wherein, in step c], a secondary power supply network energises the said high-power-demand device during the allocated usage time slot in preference to the primary said power supply network.

6. A method as claimed in claim 5, wherein the secondary power supply network is allocated by the data-communication network based on demand feedback data to the data-communication network from the primary power supply network.

7. An electronic-data-network controller for at least a high-power-demand electrical device and specifically adapted for use with a method as claimed in claim 1, the controller comprising a control element which communicates with at least a high-draw electrically powerable element of an electrical device so as to time control energisation thereof; a user input element which inputs an energisation request for energisation of the electrical device; a communication element which communicates with a distributed computer network the energisation request and which receives in return at least one dynamically allocated usage time slot from the distributed computer network based on a real-time and/or predicted energy demand across a predetermined number of said electrical devices on the distributed computer network, the dynamically allocated usage time slot being outputable to the control element; and a display element which displays the dynamically allocated usage time slot.

8. An electronic-data-network controller as claimed in claim 7, further comprising a controller housing which is separate of the said electrical device.

9. An electronic-data-network controller as claimed in claim 8, wherein the controller housing includes an electrical socket which is adapted to receive an electrical plug of the electrical device.

10. An electronic-data-network controller as claimed in claim 7, wherein the controller housing is in electrical communication with an electrical plug engagable with an electrical wall socket.

11. An electronic-data-network controller as claimed in claim 7, wherein the communication element can receive a plurality of different dynamically allocated usage time slots displayable by the display element and selectable via the user input element.

12. A power-supply management system comprising a control hub, at least one electronic-data-network controller as claimed in claim 7, and an electronic data network via which the control hub and controller intercommunicate, the control hub having a dynamic allocation system which dynamically allocates at least one usage time slot on receipt of an energisation request for an electrical device from the controller.

13. A power-supply management system as claimed in claim 12, wherein a plurality of electronic-data-network controllers are connected to the electronic data network so as to be in communication with the control hub.

14. A power-supply management system as claimed in claim 12, comprising a plurality of separate said electronic data networks, each having at least one electronic-data-network controller which is communicably isolated from each other said electronic-data-network controller on the other said electronic data networks.

15. A power-supply management system as claimed in claim 14, wherein a common said control hub communicates with the said electronic data networks.

16. A power-supply management system as claimed in claim 14, wherein each said electronic data network communicates with a dedicated said control hub.

17. A power-supply management system as claimed in claim 12, further comprising at least one electrical device controllable by the electronic-data-network controller in accordance with a dynamically allocated usage time slot outputable by the control hub.

18. A power-supply management system comprising at least two electronic-data-network controllers as claimed in claim 7, and an electronic data network via which the controllers intercommunicate, the controllers having a dynamic allocation system distributed between the controllers which dynamically allocates at least one usage time slot on input of an energisation request corresponding to an electrical device associated with one said controller.

19. A power-supply management system as claimed in claim 18, further comprising an electrical device controllable by each electronic-data-network controller in accordance with a dynamically allocated usage time slot determinable by the distributed dynamic allocation system.

20. A power-supply management system as claimed in claim 12, further comprising a secondary power supply network having a distinct separate sub-power supply which energises the or each electrical device during the allocated usage time slot in preference to mains power generated for the mains power supply network.
